(19) United States
(12) Patent Application Publication
(10) Pub. No.: US 2016/0299958 A1
(43) Pub. Date: Oct. 13, 2016

(54) METHOD AND APPARATUS FOR VISUAL LOGGING IN NETWORKING SYSTEMS

(71) Applicant: Telefonaktiebolaget L M Ericsson (publ), Stockholm (SE)

(72) Inventors: Harsh KUMAR, Bangalore (IN); Ganesh HANDIGE SHANKAR, Bangalore (IN)

(21) Appl. No.: 14/685,571

(22) Filed: Apr. 13, 2015

(51) Int. Cl. G06F 17/30

(52) U.S. Cl. CPC G06F 17/30569; G06F 17/30958; G06F 17/30185; G06F 17/30477

(57) ABSTRACT

A method in a network controller and an apparatus for visual logging is described. The method includes receiving one or more log entries from one of a plurality of network elements in a network, wherein the one or more log entries indicate the occurrence of one or more events on the network; converting the one or more log entries into one or more graph log entries using a set of one or more graph log commands, wherein log entries of a certain type are associated with a corresponding graph identifier; and storing the one or more graph log entries in a graph log file of the corresponding graph identifier.

### FIELD

Embodiments of the invention relate to the field of networking; and more specifically, to a method and apparatus for visual logging in networking systems.

### BACKGROUND

Today's networking systems are very complex and are inherently distributed. Troubleshooting issues in networking systems is a very involved task. During recent years software defined networking (SDN) has been gaining momentum. SDN does not eliminate the complexity inherent in networking systems but it moves most of the complexity to one logically centralized system—the network controller. Debugging the SDN controller logic is very hard. The currently used approach to debug issues is predominantly using text logs and network packet traces.

Debugging networking systems like an SDN controller is very complex because the controller system consists of clusters of nodes each having logs of their own. The log files with essential debug information to help debug issues can very quickly grow in size to several megabytes making it very hard to troubleshoot issues in the system. Furthermore, debugging complex controller issues takes a painful effort of analyzing multiple time synchronized log files collected from different nodes in the controller cluster and very carefully correlating them together to troubleshoot an issue in hand. Thus, a more desirable solution is needed.

### SUMMARY

According to some embodiments of the invention, a method in a network controller of visual logging is described. The method includes receiving one or more log entries from one of a plurality of network elements in a network, wherein the one or more log entries indicate the occurrence of one or more events on the network. The method further includes converting the one or more log entries into one or more graph log entries using a set of one or more graph log commands, wherein log entries of a certain type are associated with a corresponding graph identifier. The method further includes storing the one or more graph log entries in a graph log file of the corresponding graph identifier.

According to some embodiments of the invention, an apparatus for visual logging is described. The apparatus comprises a processor and a non-transitory machine readable storage medium, said storage medium containing instructions executable by said processor, and said apparatus is operative to receive one or more log entries from one of a plurality of network elements in a network, wherein the one or more log entries indicate the occurrence of one or more events on the network. The apparatus is operative to further convert the one or more log entries into one or more graph log entries using a set of one or more graph log commands, wherein log entries of a certain type are associated with a corresponding graph identifier, and to store the one or more graph log entries in a graph log file of the corresponding graph identifier.

According to some embodiments of the invention, a non-transitory computer readable medium, having stored thereon a computer program is described. The computer program, when executed by a processor, performs the operations of receiving one or more log entries from one of a plurality of network elements in a network, wherein the one or more log entries indicate the occurrence of one or more events on the network; converting the one or more log entries into one or more graph log entries using a set of one or more graph log commands, wherein log entries of a certain type are associated with a corresponding graph identifier; and storing the one or more graph log entries in a graph log file of the corresponding graph identifier.

Thus, embodiments of the invention include a method and apparatus for visual logging in networking systems.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a system 100 for a method and apparatus for visual logging in networking systems;

FIG. 2 is a block diagram illustrating an exemplary implementation of a network 200 that may output text-based log files according to certain embodiments of the invention;

FIG. 3 is block diagram illustrating the graph log command library 123 and an exemplary set of graph log commands that may be used according to certain embodiments of the invention;

FIG. 4 is block diagram illustrating an exemplary graph-based log file 130 according to certain embodiments of the invention;

FIG. 5 is a block and flow diagram illustrating an exemplary text-based log file and the conversion to a graph-based log file according to certain embodiments of the invention;

FIG. 6 is block diagram illustrating an exemplary list of available commands for the graph query 160 that may be used according to certain embodiments of the invention;

FIG. 7 is a block diagram illustrating an exemplary set of graph commands and the exemplary visual display that is produced according to certain embodiments of the invention;

FIG. 8 is a flow diagram illustrating a method 800 according to an embodiment of the invention for a method and apparatus for visual logging in networking systems;

FIG. 9A illustrates connectivity between network devices (NDs) within an exemplary network, as well as three exemplary implementations of the NDs, according to some embodiments of the invention;

FIG. 9B illustrates an exemplary way to implement the special-purpose network device 902 according to some embodiments of the invention;

FIG. 9C illustrates a network with a single network element on each of the NDs of FIG. 9A, and within this straight forward approach contrasts a traditional distributed approach (commonly used by traditional routers) with a centralized approach for maintaining reachability and forwarding information (also called network control), according to some embodiments of the invention; and

FIG. 10 illustrates, a general purpose control plane device 1004 including hardware 1040 comprising a set of one or more processor(s) 1042 (which are often COTS processors) and network interface controller(s) 1044 (NICs; also known as network interface cards) (which include physical NIs 1046), as well as non-transitory machine readable storage media 1048 having stored therein centralized control plane (CCP) software 1050.

### DESCRIPTION OF EMBODIMENTS

In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

Bracketed text and blocks with dashed borders (e.g., large dashes, small dashes, dot-dash, and dots) are used herein to illustrate optional operations that add additional features to embodiments of the invention. However, such notation should not be taken to mean that these are the only options or optional operations, and/or that blocks with solid borders are not optional in certain embodiments of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. Further, although a “Uniform Resource Locator” (URL) is one type of “Uniform Resource Identifier” (URI), these terms are used interchangeably herein to refer to a URI, which is a string of characters used to identify a name or a web resource.

The techniques shown in the figures can be implemented using code and data stored and executed on one or more electronic devices (e.g., an end station, a network device). Such electronic devices, which are also referred to as computing devices, store and communicate (internally and/or with other electronic devices over a network) code and data using computer-readable media, such as non-transitory computer-readable storage media (e.g., magnetic disks; optical disks; random access memory (RAM); read only memory (ROM); flash memory devices; phase-change memory) and transitory computer-readable communication media (e.g., electrical, optical, acoustical or other form of propagated signals, such as carrier waves, infrared signals, digital signals). In addition, such electronic devices include hardware, such as a set of one or more processors coupled to one or more other components, e.g., one or more non-transitory machine-readable storage media to store code and/or data, and a set of one or more wired or wireless network interfaces allowing the electronic device to transmit data to and receive data from other computing devices, typically across one or more networks (e.g., Local Area Networks (LANs), the Internet). The coupling of the set of processors and other components is typically through one or more interconnects within the electronic device, (e.g., busses and possibly bridges). Thus, the non-transitory machine-readable storage media of a given electronic device typically stores code (i.e., instructions) for execution on the set of one or more processors of that electronic device. Of course, one or more parts of an embodiment of the invention may be implemented using different combinations of software, firmware, and/or hardware.

As noted, debugging a network system using text logs from multiple network elements can be time consuming and highly inefficient. To improve the method of debugging network systems, embodiments of the invention provide for methods, systems, and apparatuses for multi-level threshold service level agreement (SLA) violation mitigation. Typical networking systems can be often modeled as a finite state machine or a graph consisting of nodes and edges. A node may represent a network element in the network, and an edge may represent a connection between two nodes (whether the connection be wired or wireless). This model can represent the state of the system at any point in time. In many cases, textual logs track the state space of a running system for use in debugging. Instead of textual logs, embodiments of the invention the logging process represents the logs as temporal changes in the state of the system represented as a graph. Instead of print statements which prints a text log to a file, embodiments of the invention provide a library of routines which keeps track of incremental temporal state changes of the system in the form of an extended graph. Queries can then be made to such a temporal graph to debug issues more effectively and more formally, and the graph can be manipulated to gain crucial insights. For example extracting how the system state changes during a time interval before a failure happens can be a simple high level query which can be seen visually.

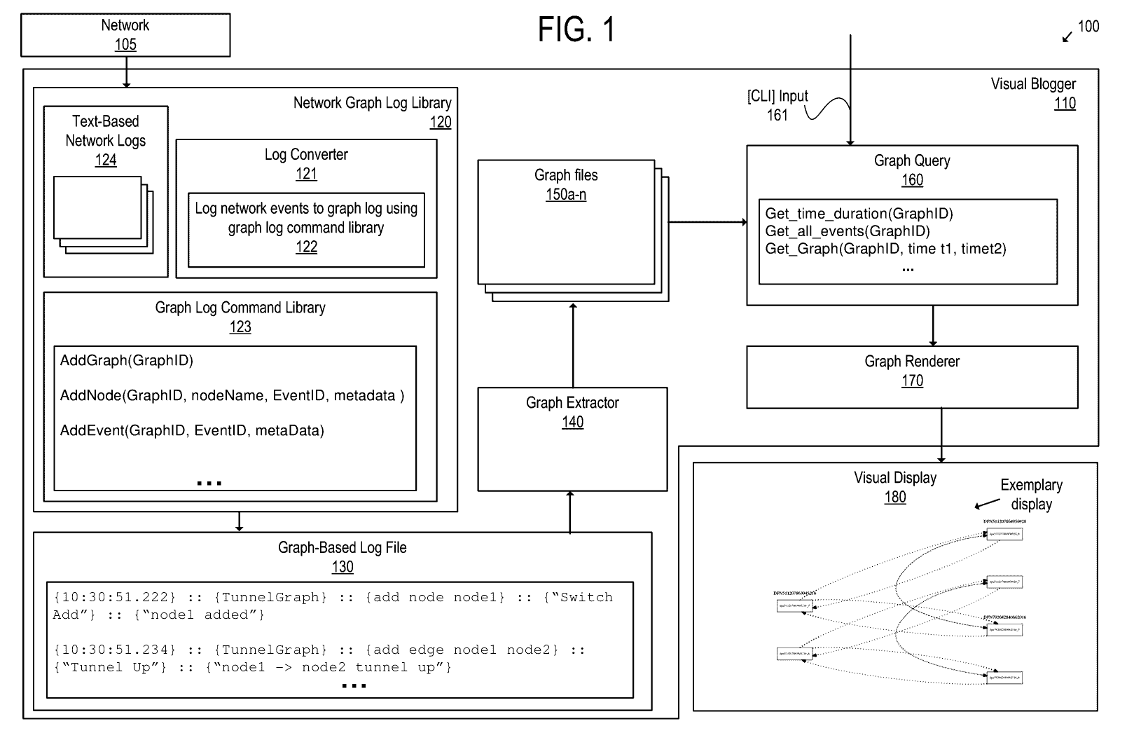

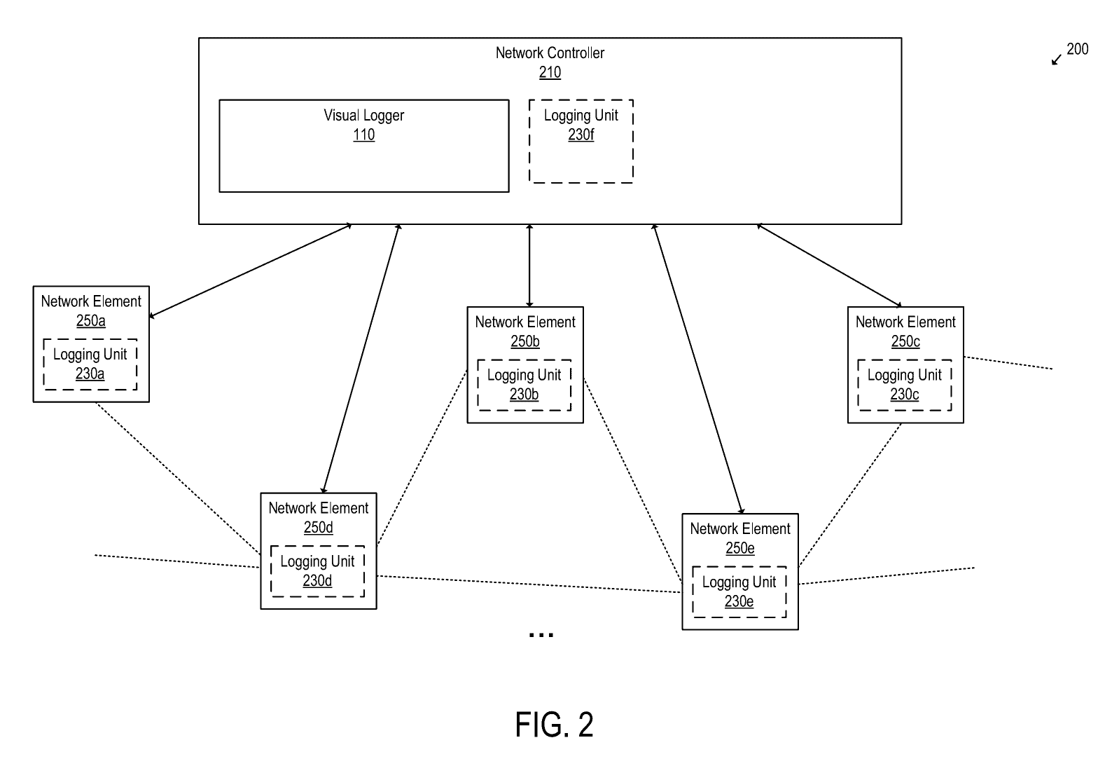

FIG. 1 is a block diagram illustrating a system 100 for a method and apparatus for visual logging in networking systems. System 100 includes network 105. Network 105 represents the SDN network, or other network, from which text-based logs are being sent to or retrieved by visual logger 110. These text based logs may be generated by one or more network elements or network controllers in the network 105. These logs may include information such as when a node is added or removed from the network, when an edge is added or removed from the network, when an edge or node enters a down state, when an edge or node enters an up state, when errors occur on the network, performance metrics, network topology information, information regarding routing protocols (e.g., link state advertisements), and so on. An exemplary implementation of network 105 will be described with reference to FIG. 2.

Visual logger 110 receives the text-based logs from the network 105 and may store them in network logs 124. Network logs 124 may include logs from multiple network elements and network controllers in network 105 over various time periods.

These text-based logs may then be converted by a log converter 121 at block 122 to a graph-based log using the graph log command library 123. This conversion may be done in real time or using a batch process. The text-based logs from the network 105 are typically state based. In other words, they are a textual representation of changes in the state of the system. For example, if a node is no longer reachable, a log entry may indicate this; if an edge is down, then a log entry may indicate that a port is disconnected; and if a link state announcement packet is received, a log entry may be generated, and so on. As the format of the text-based log may be different depending upon the type of network, the log converter 121 may be configured to be able to read the format of the particular text-based logs that it is converting. In some embodiments, the log converter 121 has a plugin architecture, wherein a plugin module is configured with the log converter 121 that can understand the format of whichever text-based log is being fed to the log converter 121.

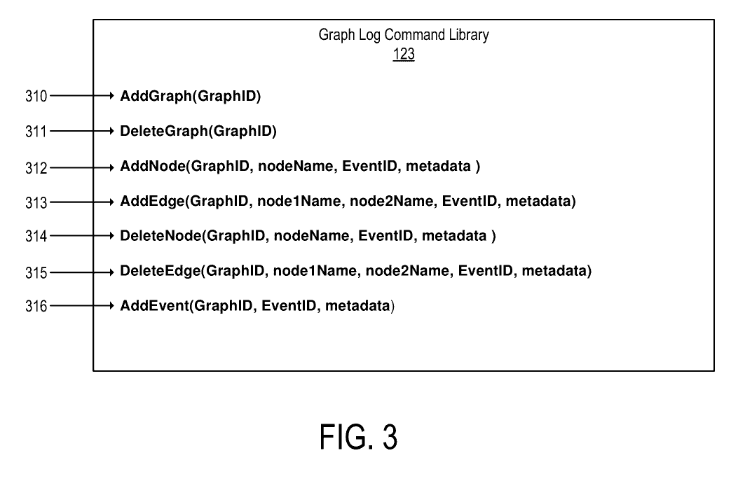

The log converter 121 may use a set of standardized library commands or functions to write the graph-based log file. These functions may be stored in a graph log command library 123. Calling each library function may add one or more graph-based log entries into the graph-based log file. In some embodiments, an additional log writer writes the entries in the log based on the library commands it receives. An example of a command may be “AddNode(GraphID, nodeName, EventID, metadata). This adds an entry into a graph-based log file indicating that a node with “nodeName” has been added to the network represented by “GraphID”. The graph-based log file may log multiple graphs each with its own “GraphID”. In some embodiments, the “EventID” is an identifier associated with the graph and may correspond to a time stamp of the graph entry. In other embodiments, “EventID” indicates a type of the event, such as “Tunnel Down”, etc. By placing an “EventID” into the graph-based log, one may later query the graph-based log using the “EventID”. The “metadata” is optional information regarding the entry that may be added and may be displayed when the graph-based log file is rendered as a visual graph. Additional details regarding the graph log commands will be described below with reference to FIG. 3.

In some embodiments, the network log 124, log converter 121, and/or the graph log command library 123 are a part of a network graph log library module 120. The input into this module is the text-based network logs, and the output is the graph-based log file 130. Additionally, in some embodiments, the inputs into the graph log commands (e.g., “GraphID”) are strings, however in other embodiments the inputs may be of a different format.

In some cases each network element in the network 105 may each log the same event, resulting in redundant log entries. The log converter 121 may include a temporary cache to store those network events that it has already seen, or may scan the graph-based log file 130 to determine if the event was already logged. If the event has already been seen or logged, the log converter 121 will not enter it again into the graph-based log file 130. This synchronization of log files allows the system to present a coherent account of network activity.

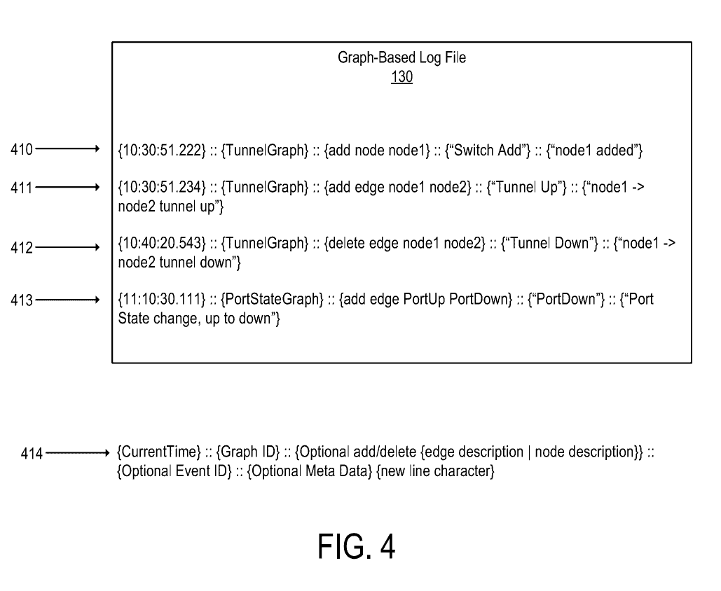

After the network graph log library 120 converts the text-based network log file(s), it outputs a graph-based log file 130. The format for this file is standardized and does not vary significantly in regards to the format type of the inputted text-based log files. In some embodiments, the format of each entry in this graph-based log file 130 includes a timestamp, a graph identifier (i.e., “GraphID”), an optional entry indicating whether a node or edge has been added or deleted, an optional event identifier entry (i.e., “EventID”), and optional metadata information. This graph-based log file may include logs for different graphs with different graph identifiers. Further details regarding the format and contents of the graph-based log file 130 will be described with reference to FIG. 4.

The graph-based log file 130 may be created using a batch process or may be updated in real time. After one or more entries are placed into the graph-based log file 130, the graph extractor 140 may take the graph-based log file 130 and extract the individual graphs from the graph-based log file and create one or more graph files 150a-n. These graphs files 150 may also be in the same format as the graph-based log file or may be in a binary or other file format to allow for easier, faster, or more efficient rendering of the graph to a visual medium. A conversion to another format may also take place for another reason as well. For these different formats, the graph extractor 140 may include a plugin architecture to allow for easy conversion to different graph files 150 with different formats.

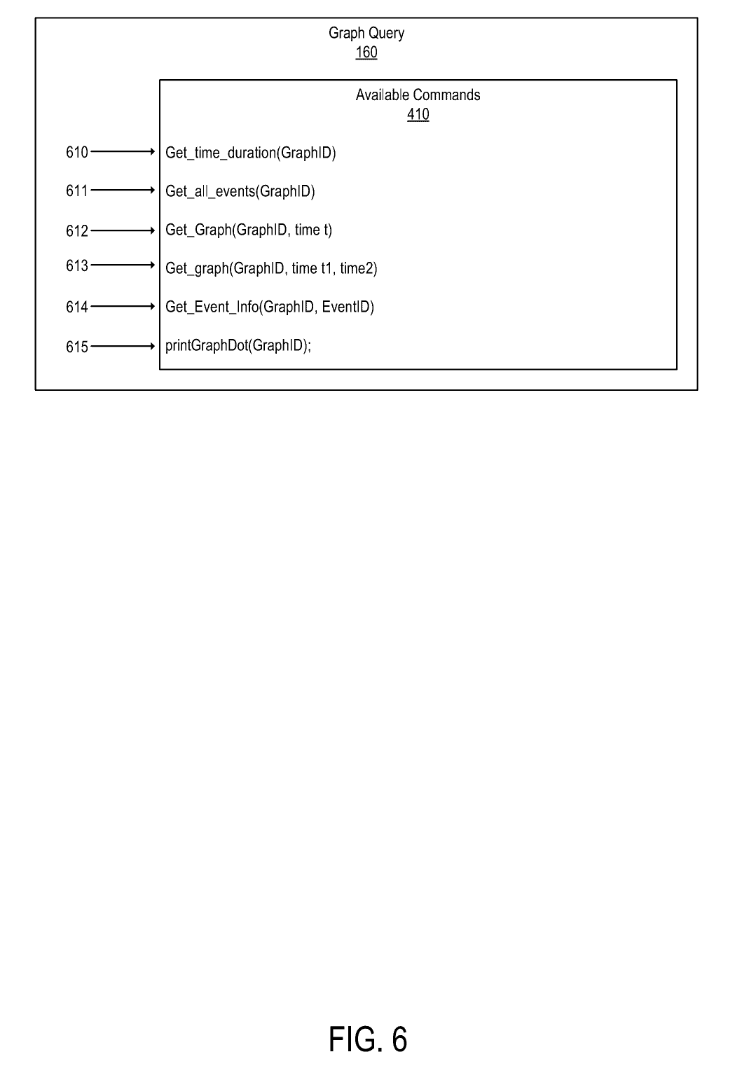

After the graphs files 150 are extracted from the graph-based log file by the graph extractor 140, they can then be rendered to a visual display 180 or other visual medium, e.g., printed on display media such as paper. To do this, the visual logger 110 receives an external input 161 to query the graph file at graph query 160. In some embodiments, the external input 161 is a command line interface input. The graph query 160 processes the corresponding graph file 150 according to the input query and causes the graph renderer 170 to render the results on visual display 180 (or other visual medium). Examples of queries accepted by graph query 160 include “Get_time_duration(GraphID)”, which is processed by graph query 160 and causes the graph renderer 170 to render on the visual display 180 the log start time and log end time for the graph with graph identifier corresponding to “GraphID”. As another example, the query “Get_graph(GraphID, time t1, time t2) may cause the graph renderer 170 to render on the visual display 180 an animated display of the graph with graph identifier “GraphID” between the time t1 and the time t2. Additional details regarding the graph query functions 160 will be described with reference to FIG. 6.

Using such a system and method has many advantages. Having such a system for troubleshooting may reduce the resolution time to fix bugs and issues by an order of magnitude. The graph log can further be exported to various graph manipulation tools to gain visual insights very quickly. Additionally, such a system and method provides automated diagrams which eases communication on product related issues between development and support organizations.

FIG. 2 is a block diagram illustrating an exemplary implementation of a network 200 that may output text-based log files according to certain embodiments of the invention. In some embodiments, this network 200 may be the same as the network 105 as shown in FIG. 1. Network 200 includes a plurality of network elements 250. These may be SDN network elements, and may also be known as forwarding elements. In the case of an SDN, the network elements include the functionality of the data plane of the network. They may include one or more forwarding tables to forward ingress packets and data to certain egress ports based on the rules in the forwarding tables. Additionally, the forwarding tables may specify rules which the network elements 250 may use to modify packets that they receive (e.g., decrease the time to live (TTL) of packets that are received).

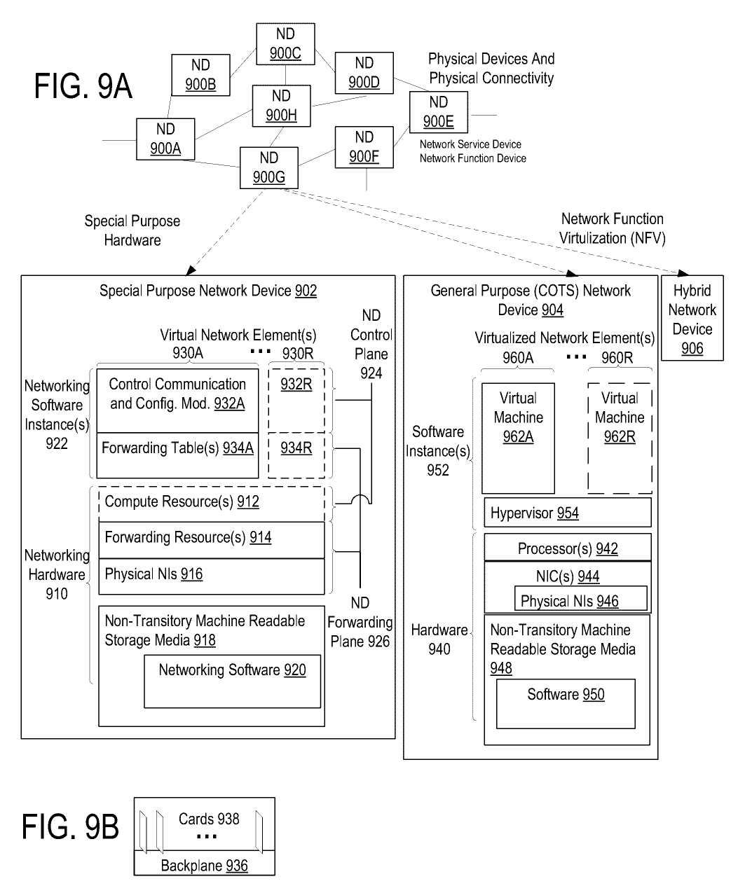

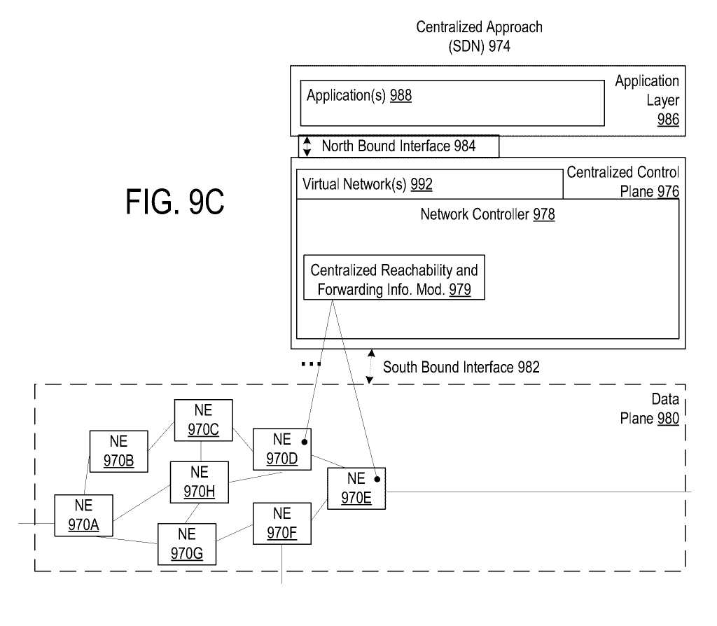

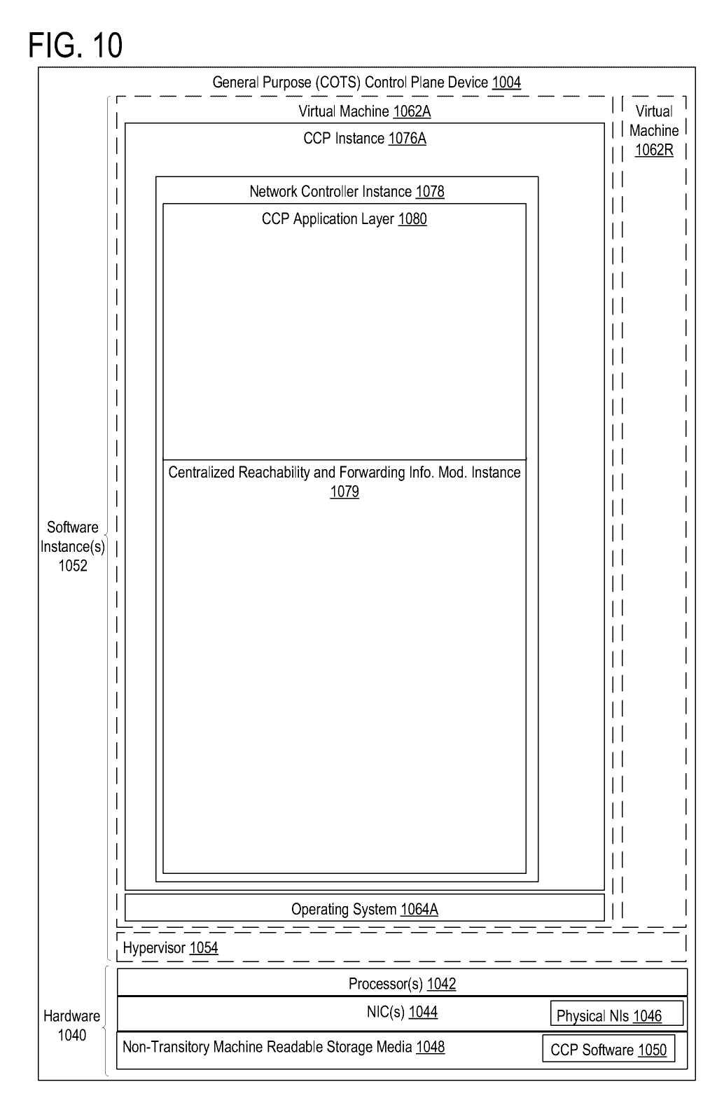

In the case of an SDN, the control plane functionality is in an SDN network controller 210. This network controller 210 is communicatively coupled to the network elements 250. This network controller 210 may receive packets from the network elements 250 for inspection, upon which it may propagate rules to the forwarding tables of one or more of the network elements 250 regarding that type of packet. The communication between the network elements 250 and the network controller 210 may be achieved using an SDN protocol, such as OpenFlow (Open Networking Foundation, Palo Alto, Calif.). Additional details regarding various functionality and embodiments of SDN networks will be described below with reference to FIGS. 9 and 10.

In some embodiments, each network element 250 may have a logging unit 230. This logging unit 230 may log various activities of the network. Network activities that are logged may include when a network element is added or removed, when a connection (edge) between two network elements is added or removed, when a connection goes down or is restored, when an event occurs, when a failure event occurs, when network traffic is sent or received (including source and destination information, port information, protocol information, etc.), when network routing protocol information is exchanged (e.g., link state advertisements), and any other events that may be of interest for debugging network conditions or for monitoring network activity and statistics.

The events logged by the logging unit may logged using a standardized format, or may be a proprietary format. These logs are text-based, and in many cases may be difficult to analyze for debugging purposes. The network elements 250 may send these text-based logs, either in real time or on a periodic schedule, to the network controller 210, where they are received by the visual logger 110 according to the methods described above. The network controller itself may have a logging unit 230 to log changes in the control plane information and other activities that only the network controller 210 may see in the network (e.g., the existence of an isolated network element).

Once the visual logger 110 processes these network logs, it may be able to visually display a version of the network according to the actual physical topology of the network. For example, in the exemplary network 200, the visual logger 110 may be able to show on the visual display 180 a graphical version of the exemplary network 200 in a format that may be similar to the illustrative version shown in FIG. 2. Furthermore, this graphical version may be animated and show the changes in state for the network. Such a centralized graphical means of displaying the changes in the network can greatly facilitate network debugging and analysis in comparison to the current method of laboriously analyzing cryptic text-based logs from multiple network elements 250 that may not be synchronized with each other.

FIG. 3 is block diagram illustrating the graph log command library 123 and an exemplary set of graph log commands that may be used according to certain embodiments of the invention. Note that elements within the parentheses are placeholders for arguments and/or parameters for the commands. Line 310 indicates the command “AddGraph(GraphID)”. This command instructs the log converter 121 to add a new graph identifier with the name “GraphID” to the graph-based log file. Subsequently, a user may be able to send a query to graph query 160 to request that this graph be rendered. This command may be used when the log converter 121 detects that the test-based network logs 124 refer to a separate or new network. For example, a network element may have received topology information for a separate network beyond the edge of the current network, and this network may be assigned a new graph identifier by the log converter 121. Alternatively, an administrator may set which graph identifier to use for all current log entries that are written to the graph-based log file, and the log converter 121 uses the same graph identifier until the administrator changes it again. This may be useful when debugging a certain event as the administrator may temporarily set the graph identifier to a different and unique one.

Line 311 indicates the command “DeleteGraph(GraphID)”. This command instructs the log converter 121 to delete the entries related to the graph with graph identifier “GraphID” from the graph-based log file. After being deleted, this particular graph is no longer accessible. An administrator may issue this command to the log converter 121 to remove old entries, or this command may be automatically issued to the log converter 121 as a garbage collection method.

Line 312 indicates the command “AddNode(GraphID, nodeName, EventID, metadata).” This adds an entry into the graph-based log file 130 indicating the addition of a new node with node identifier “nodeName” to the graph with graph indentifier “GraphID”. The node may be a network element, a network element and port combination, or some other object in the network. “EventID” is an identifier that is associated with the graph and corresponds to a timestamp or other indicator (e.g., an event type) for the event (the AddNode) occurred in the physical network. The “EventID” may be used to filter query results when querying the graph. “metadata” is an optional parameter that can be shown during the rendering of the graph for the event related to this command. The log converter 121 may use this command when it determines from the text-based network logs 124 that a new network element or node in the network 105 has been detected or has been added to the network.

Line 313 indicates the command “AddEdge(GraphID, node1Name, node2Name, EventID, metadata)”. This adds an entry into the graph-based log file 130 indicating the addition of a new edge or connection between a first node with node identifier “node1Name” and a second node with node identifier “node2Name”. The parameters “GraphID”, “EventID”, and “metadata” function the same way as shown above. The log converter 121 may use this command when it determines from the text-based network logs 124 that a new connection is established between two network elements in the network 105.

Line 314 indicates the command “DeleteNode(GraphID, nodeName, EventID, metadata)”. This adds an entry into the graph-based log file 130 indicating the removal of an existing node with node identifier “nodeName”. The parameters “GraphID”, “EventID”, and “metadata” function the same way as shown above. The log converter 121 may use this command when it determines from the text-based network logs 124 that a network element has been removed or dropped from the network 105. In some embodiments, when a network element experiences a failure, the log converter 121 uses this command to add a removal entry for that network element and indicates in the metadata parameter that a failure has been detected for that network element.

Line 315 indicates the command “DeleteEdge(GraphID, node1Name, node2Name, EventID, metadata)”. This adds an entry into the graph-based log file 130 indicating the removal of an existing connection between a first node with node identifier “node1Name” and a second node with node identifier “node2Name”. The parameters “GraphID”, “EventID”, and “metadata” function the same way as shown above. The log converter 121 may use this command when it determines from the text-based network logs 124 that a connection between two network elements has been removed or dropped from the network 105. In some embodiments, when a connection between two network elements experiences a failure, the log converter 121 uses this command to add a removal entry for that connection and indicates in the metadata parameter that a failure has been detected for that connection.

Line 316 indicates the command “AddEvent(GraphID, EventID, metadata)”. This adds an entry into the graph-based log file 130 to log any type of event. In this case, information regarding the event is likely to be sent via the “metadata” parameter. This event may not fit within the other commands shown above. The log converter 121 may use this command when it determines from the text-based network logs 124 that something unusual has happened on network 105. For example, an event may be recorded to indicate when an administrator brings some or all of the network down for maintenance. As this is not an actual failure, it should not be indicated as such. In some cases, the text-based network logs 124 are unable to indicate the special status of an event. In such a case, an administrator may issue this command directly.

In some embodiments, the AddNodeQ, DeleteNodeQ, AddEdgeQ, and DeleteEdge( ) commands also include an additional parameter of an “attribute”. This attribute parameter may be used to specify various visual attributes for that node or edge as they are shown in the visual render of the graph. While the commands have particular names as specified above, in other embodiments different names are used for the commands.

FIG. 4 is block diagram illustrating an exemplary graph-based log file 130 according to certain embodiments of the invention. Line 414 indicates the general format of each entry. The first bracket entry is the timestamp (current time) of the entry or of the occurrence of the event that is logged in that entry if the entry was written later. The second bracket entry is the graph identifier (“Graph ID”). The third bracketed entry is optional and is the description of the event activity that occurred on the network, and can be an “add” or “delete” event, with an edge identifier or a node identifier. The fourth bracketed entry is an optional entry indicating the event identifier (“EventID”). The fifth bracketed entry is an optional entry with the metadata information. The last bracketed entry indicates that the log entry terminates with a newline character.

Line 410 indicates the addition of a node with node indicator “node 1”. This entry may have been written using the “AddNodeQ” library command. The first bracketed item in the log entry is a timestamp. This may correspond to when the entry was written. The second bracket item is a graph identifier (“TunnelGraph). This may correspond to the “GraphID” parameter. The third bracket item indicates the event, which is an add node event, specifically a node with node identifier “node1”. The fourth bracketed item is the event identifier, which in this case is “Switch Add”. The fifth bracketed item is the metadata information, which in this case is “node1 added”.

Line 411 indicates an addition of an edge between the nodes with node identifiers “node1” and “node2”. This entry may have been written using the “AddEdgeQ” library command. The bracketed entries are similar to the ones described above, however the event description now indicates the addition of an edge between “node1” and “node2”, the event identifier is changed to “Tunnel Up”, and the metadata is changed.

Line 412 indicates a deletion of the edge between “node1” and “node2”. This entry may have been written using the “DeleteEdgeQ” library command. The bracketed entries are similar to the ones described above, however the event description now indicates the deletion of an edge between “node1” and “node2”, the event identifier is changed to “Tunnel Down”, and the metadata is changed.

Line 413 indicates an addition of the edge between nodes with node identifiers “PortUp” and “PortDown”. This entry may have been written using the “AddEdgeQ” library command. The bracketed entries are similar to the ones described above, however the graph identifier is now “PortStateGraph”, the event identifier is “PortDown”, and the metadata is changed. Note that while the log entries with the “TunnelGraph” graph indicator may have been used to track the status of a network tunnel, and so had tunnel related event identifiers, the entries related to the “PortStateGraph” graph identifier may have been used to track that status of ports on a network element, and thus use different terminology for the event identifier.

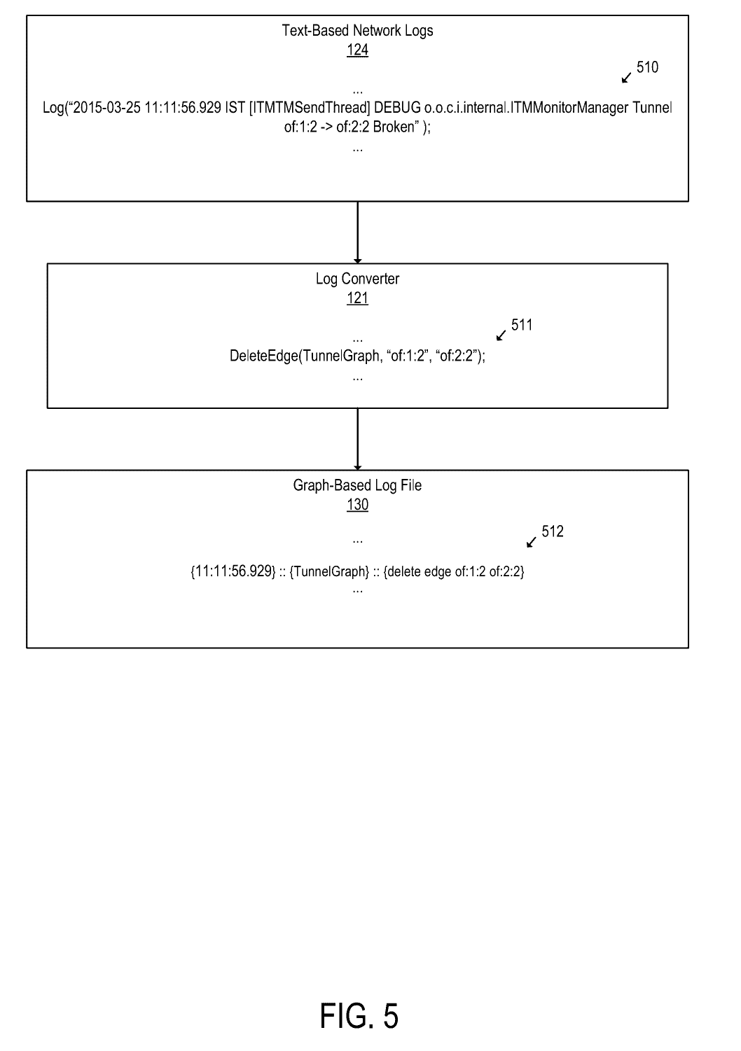

FIG. 5 is a block and flow diagram illustrating an exemplary text-based log file and the conversion to a graph-based log file according to certain embodiments of the invention. Line 510 indicates the original text-based log entry from the text-based network logs 124. Note that this entry is very complicated and hard to parse. This exemplary log entry is typical of how current network log entries appear. However, after a very detailed and thorough analysis, one may see that this entry indicates that at approximately 11:11:56, the tunnel between network elements “of:1:2” (i.e., port 2 of node 1) and “of:2:2” (i.e., port 2 on node 2) is broken.

The log converter 121 receives this log entry and automatically parses it and choses the library command “DeleteEdgeQ” with the node names and the graph identifier of “TunnelGraph” as shown at line 511. This identifier may be selected automatically based on the analysis of the log file or based on input from an administrator. This library command then causes an entry to be written into the graph-based log file 130 as shown at line 512 indicating that the edge between the (specified ports of the) two nodes should be deleted. In some embodiments, an event identifier and metadata may automatically be determined and placed in the graph-based log file 130 based on the original text-based log entry.

FIG. 6 is block diagram illustrating an exemplary list of available commands for the graph query 160 that may be used according to certain embodiments of the invention. These commands may be inputted through the input 161 to the graph query 160 in order to cause the graph query 160 to retrieve the appropriate graph file 150, process it, and cause the graph renderer 170 to render the desired graph specified by the command on the visual display 180.

Line 610 indicates a command “Get_time_duration(GraphID)” that may cause the graph renderer to display the timestamp for the earliest entry in the graph-based log file for a graph with graph identifier matching “GraphID” and the timestamp for the last entry of the same graph. This is displayed as a text output instead of a graphical output.

Line 611 indicates a command “Get_all_events(GraphID)” which may cause the graph render to display all the event identifier that are associated with the graph with graph identifier indicated by “GraphID”. This is also a text output.

Line 612 indicates a command “Get_Graph(GraphID, time t)”. This may cause the graph renderer 170 to render the graph with graph identifier “GraphID” in the state that it was at time t. If this state does not exist in the graph files 150, an error may be displayed instead. The display is a graphical display and is static.

Line 613 indicates a command “Get_graph(GraphID, time t1, time2)”. This may cause the graph renderer 170 to render the graph with graph identifier “GraphID” in the state that it was from time t1 to time t2. If this state does not exist in the graph files 150, an error may be displayed instead. The graph is displayed graphically and is animated to show any change in state for the graph (e.g., when a node is deleted, etc.). The visual display 180 may also include user interface elements to allow the user to pause, speed up, slow down, and otherwise manipulate the animation of the graph.

Line 614 indicates a command “Get_Event_Info(GraphID, EventID)”. This causes the graph renderer 170 to display the timestamps for all log entries for the graph with graph identifier “GraphID” that have the event identifier “EventID”. This may be useful to determine when a particular event occurred for a graph. The display is text based.

Line 615 indicates a command “printGraphDot(GraphID);”. This may cause the graph query 160 to output the graph with graph identifier “GraphID” in a standardized file format (e.g., DOT format). The name of the file may be the same as the graph identifier.

While the commands have particular names as specified above, in other embodiments different names are used for the commands.

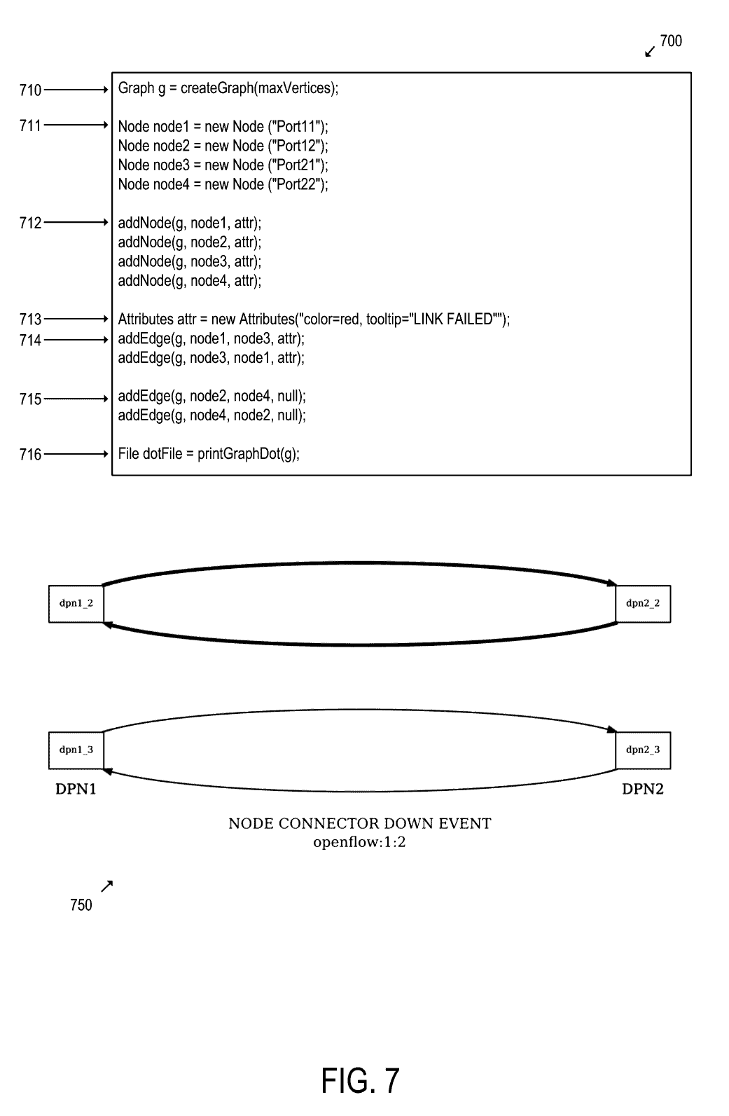

FIG. 7 is a block diagram illustrating an exemplary set of graph commands and the exemplary visual display that is produced according to certain embodiments of the invention. Block 700 shows the commands used to create the graph-based log. Line 710 in block 700 indicates the command used to create the graph with identifier “g”. Line 711 indicates the creation of four nodes. Each node represents a network element and port combination. Thus, in this case, each port and network element is represented by a different node in the graph.

Line 713 indicates that an attribute is set to the color red and with a tooltip indicating that the link has failed. This attribute is used later as indicated by line 714 to add two edges with this attribute. Here, although the link has failed, the log converter 121 has been configured to instead mark these edges with a red color attribute to indicate that they have failed instead of not adding or deleting the edges from the graph.

Line 715 indicates that two edges are added. Note that these have a null attribute, and so they are not colored red. Line 716 indicates a command that requests that the graph be stored in a file. The visual display of the graph from these commands is indicated by 750. Note that there are four nodes, with the two edges between two nodes set to a red color, and the edges between the other two nodes set to a green “up” color. Also note that the direction of the edges as indicated by the arrows is determined by the order of the nodes in the “AddEdgeQ” command.

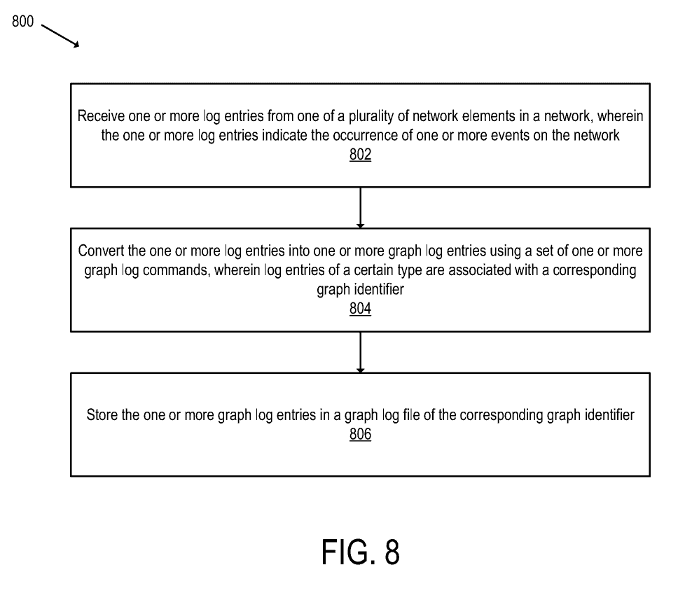

FIG. 8 is a flow diagram illustrating a method 800 according to an embodiment of the invention for a method and apparatus for visual logging in networking systems. The operations in flow diagram 800 may be performed by the network controller 210. At block 802, the network controller receives one or more log entries from one of a plurality of network elements in a network, wherein the one or more log entries indicate the occurrence of one or more events on the network. At block 804, the network controller converts the one or more log entries into one or more graph log entries using a set of one or more graph log commands, wherein log entries of a certain type are associated with a corresponding graph identifier. At block 806, the network controller stores the one or more graph log entries in a graph log file of the corresponding graph identifier.

In some embodiments, the one or more graph log commands includes at least one of an add graph command, a delete graph command, an add node command, a delete node command, an add edge command, a delete edge command, and an add event command. In some embodiments, each of the one or more graph log commands includes as a parameter at least a graph identifier, an event identifier, a metadata entry, and a visual attributes entry.

In some embodiments, the add node command and the delete node command each include as parameters a node identifier. In some embodiments, the add edge command and the delete edge command each include as parameters a first node identifier and a second node identifier, wherein the first node identifier identifies the source of the edge and the second node identifier identifies the destination of the edge.

In some embodiments, the network controller further receives one or more query commands including the graph identifier and displays the graph corresponding to the graph identifier based on the query command.

In some embodiments, the one or more query commands includes at least one of a get time duration command, a get all events command, a display graph at a first timestamp command, a display graph between the first timestamp and a second timestamp command, and a get event information command.

FIG. 9A illustrates connectivity between network devices (NDs) within an exemplary network, as well as three exemplary implementations of the NDs, according to some embodiments of the invention. FIG. 9A shows NDs 900A-H, and their connectivity by way of a lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 900A, E, and F illustrates that these NDs act as ingress and egress points for the network (and thus, these NDs are sometimes referred to as edge NDs; while the other NDs may be called core NDs).

Two of the exemplary ND implementations in FIG. 9A are: 1) a special-purpose network device 902 that uses custom application—specific integrated—circuits (ASICs) and a proprietary operating system (OS); and 2) a general purpose network device 904 that uses common off-the-shelf (COTS) processors and a standard OS.

The special-purpose network device 902 includes networking hardware 910 comprising compute resource(s) 912 (which typically include a set of one or more processors), forwarding resource(s) 914 (which typically include one or more ASICs and/or network processors), and physical network interfaces (NIs) 916 (sometimes called physical ports), as well as non-transitory machine readable storage media 918 having stored therein networking software 920. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 900A-H. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

In some embodiments, each of the virtual network elements 930A-R performs the functionality of a network element as described with reference to FIGS. 1-8.

The special-purpose network device 902 is often physically and/or logically considered to include: 1) optionally, a ND control plane 924 (sometimes referred to as a control plane) comprising the compute resource(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the compute resource(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). In some embodiments, ND 902 does not include a control card. These cards are coupled together through one or more interconnect mechanisms illustrated as backplane 936 (e.g., a first full mesh coupling the line cards and a second full mesh coupling all of the cards). Returning to FIG. 9A, the general purpose network device 904 includes hardware 940 comprising a set of one or more processor(s) 942 (which are often COTS processors) and network interface controller(s) 944 (NICs; also known as network interface cards) (which include physical NIs 946), as well as non-transitory machine readable storage media 948 having stored therein software 950. During operation, the processor(s) 942 execute the software 950 to instantiate a hypervisor 954 (sometimes referred to as a virtual machine monitor (VMM)) and one or more virtual machines 962A-R that are run by the hypervisor 954, which are collectively referred to as software instance(s) 952. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 962A-R, and that part of the hardware 940 that executes that virtual machine (be it hardware dedicated to that virtual machine and/or time slices of hardware temporally shared by that virtual machine with others of the virtual machine(s) 962A-R), forms a separate virtual network element(s) 960A-R. In some embodiments, a virtual network element 960 performs the functionality of a network element as described with reference to FIGS. 1-8.

The virtual network element(s) 960A-R perform similar functionality to the virtual network element(s) 930A-R. For instance, the hypervisor 954 may present a virtual operating platform that appears like networking hardware 910 to virtual machine 962A, and the virtual machine 962A may be used to implement functionality similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 962A-R differently. For example, while embodiments of the invention are illustrated with each virtual machine 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 954 includes a virtual switch that provides similar forwarding services as a physical Ethernet switch. Specifically, this virtual switch forwards traffic between virtual machines and the NIC(s) 944, as well as optionally between the virtual machines 962A-R; in addition, this virtual switch may enforce network isolation between the VNEs 960A-R that by policy are not permitted to communicate with each other (e.g., by honoring virtual local area networks (VLANs)). The third exemplary ND implementation in FIG. 9A is a hybrid network device 906, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 968, 2460, 2675, 4113, and 5405), Transmission Control Protocol (TCP) (RFC 993 and 1180), and differentiated services (DSCP) values (RFC 2474, 2475, 2597, 2983, 3086, 3140, 3246, 3247, 3260, 4594, 5865, 3289, 3290, and 3317).

FIG. 9C illustrates a network with a single network element on each of the NDs of FIG. 9A, and within this straight forward approach contrasts a traditional distributed approach (commonly used by traditional routers) with a centralized approach for maintaining reachability and forwarding information (also called network control), according to some embodiments of the invention. Specifically, FIG. 9C illustrates network elements (NEs) 970A-H with the same connectivity as the NDs 900A-H of FIG. 9A.

FIG. 9C illustrates a centralized approach 974 (also known as software defined networking (SDN)) that decouples the system that makes decisions about where traffic is sent from the underlying systems that forwards traffic to the selected destination. In some embodiments, this centralized approach is used for the SDN as described with reference to FIGS. 1-8. The illustrated centralized approach 974 has the responsibility for the generation of reachability and forwarding information in a centralized control plane 976 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 976 has a south bound interface 982 with a data plane 980 (sometime referred to the infrastructure layer, network forwarding plane, or forwarding plane (which should not be confused with a ND forwarding plane)) that includes the NEs 970A-H (sometimes referred to as switches, forwarding elements, data plane elements, or nodes). The centralized control plane 976 includes a network controller 978, which includes a centralized reachability and forwarding information module 979 that determines the reachability within the network and distributes the forwarding information to the NEs 970A-H of the data plane 980 over the south bound interface 982 (which may use the OpenFlow protocol). Thus, the network intelligence is centralized in the centralized control plane 976 executing on electronic devices that are typically separate from the NDs. In some embodiments, network controller 978 includes the functionality of the network controller 210 as described with reference to FIGS. 1-8.

For example, where the special-purpose network device 902 is used in the data plane 980, each of the control communication and configuration module(s) 932A-R of the ND control plane 924 typically include a control agent that provides the VNE side of the south bound interface 982. In this case, the ND control plane 924 (the compute resource(s) 912 executing the control communication and configuration module(s) 932A-R) performs its responsibility for participating in controlling how data (e.g., packets) is to be routed (e.g., the next hop for the data and the outgoing physical NI for that data) through the control agent communicating with the centralized control plane 976 to receive the forwarding information (and in some cases, the reachability information) from the centralized reachability and forwarding information module 979 (it should be understood that in some embodiments of the invention, the control communication and configuration module(s) 932A-R, in addition to communicating with the centralized control plane 976, may also play some role in determining reachability and/or calculating forwarding information—albeit less so than in the case of a distributed approach; such embodiments are generally considered to fall under the centralized approach 974, but may also be considered a hybrid approach).

While the above example uses the special-purpose network device 902, the same centralized approach 974 can be implemented with the general purpose network device 904 (e.g., each of the VNE 7A60A-R performs its responsibility for controlling how data (e.g., packets) is to be routed (e.g., the next hop for the data and the outgoing physical NI for that data) by communicating with the centralized control plane 976 to receive the forwarding information (and in some cases, the reachability information) from the centralized reachability and forwarding information module 979; it should be understood that in some embodiments of the invention, the VNEs 7A60A-R, in addition to communicating with the centralized control plane 976, may also play some role in determining reachability and/or calculating forwarding information—albeit less so than in the case of a distributed approach) and the hybrid network device 906. In fact, the use of SDN techniques can enhance the NFV techniques typically used in the general purpose network device 904 or hybrid network device 906 implementations as NFV is able to support SDN by providing an infrastructure upon which the SDN software can be run, and NFV and SDN both aim to make use of commodity server hardware and physical switches.

FIG. 9C also shows that the centralized control plane 976 has a north bound interface 984 to an application layer 986, in which resides application(s) 988. The centralized control plane 976 has the ability to form virtual networks 992 (sometimes referred to as a logical forwarding plane, network services, or overlay networks (with the NEs 970A-H of the data plane 980 being the underlay network)) for the application(s) 988. Thus, the centralized control plane 976 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 9C illustrates the simple case where each of the NDs 900A-H implements a single NE 970A-H, it should be understood that the network control approaches described with reference to FIG. 9C also work for networks where one or more of the NDs 900A-H implement multiple VNEs (e.g., VNEs 930A-R, VNEs 960A-R, those in the hybrid network device 906). Alternatively or in addition, the network controller 978 may also emulate the implementation of multiple VNEs in a single ND. Specifically, instead of (or in addition to) implementing multiple VNEs in a single ND, the network controller 978 may present the implementation of a VNE/NE in a single ND as multiple VNEs in the virtual networks 992 (all in the same one of the virtual network(s) 992, each in different ones of the virtual network(s) 992, or some combination). For example, the network controller 978 may cause an ND to implement a single VNE (a NE) in the underlay network, and then logically divide up the resources of that NE within the centralized control plane 976 to present different VNEs in the virtual network(s) 992 (where these different VNEs in the overlay networks are sharing the resources of the single VNE/NE implementation on the ND in the underlay network).

While some embodiments of the invention implement the centralized control plane 976 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 976, and thus the network controller 978 including the centralized reachability and forwarding information module 979, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 10 illustrates, a general purpose control plane device 1004 including hardware 1040 comprising a set of one or more processor(s) 1042 (which are often COTS processors) and network interface controller(s) 1044 (NICs; also known as network interface cards) (which include physical NIs 1046), as well as non-transitory machine readable storage media 1048 having stored therein centralized control plane (CCP) software 1050.

In embodiments that use compute virtualization, the processor(s) 1042 typically execute software to instantiate a hypervisor 1054 (sometimes referred to as a virtual machine monitor (VMM)) and one or more virtual machines 1062A-R that are run by the hypervisor 1054; which are collectively referred to as software instance(s) 1052. A virtual machine is a software implementation of a physical machine that runs programs as if they were executing on a physical, non-virtualized machine; and applications generally are not aware they are running on a virtual machine as opposed to running on a “bare metal” host electronic device, though some systems provide para-virtualization which allows an operating system or application to be aware of the presence of virtualization for optimization purposes. Again, in embodiments where compute virtualization is used, during operation an instance of the CCP software 1050 (illustrated as CCP instance 1076A) on top of an operating system 1064A are typically executed within the virtual machine 1062A. In embodiments where compute virtualization is not used, the CCP instance 1076A on top of operating system 1064A is executed on the “bare metal” general purpose control plane device 1004.

The operating system 1064A provides basic processing, input/output (I/O), and networking capabilities. In some embodiments, the CCP instance 1076A includes a network controller instance 1078. The network controller instance 1078 includes a centralized reachability and forwarding information module instance 1079 (which is a middleware layer providing the context of the network controller 978 to the operating system 1064A and communicating with the various NEs), and an CCP application layer 1080 (sometimes referred to as an application layer) over the middleware layer (providing the intelligence required for various network operations such as protocols, network situational awareness, and user—interfaces). At a more abstract level, this CCP application layer 1080 within the centralized control plane 976 works with virtual network view(s) (logical view(s) of the network) and the middleware layer provides the conversion from the virtual networks to the physical view. In some embodiments, network controller instance 1078 includes the functionality of the network controller 210 as described with reference to FIGS. 1-8.

The centralized control plane 976 transmits relevant messages to the data plane 980 based on CCP application layer 1080 calculations and middleware layer mapping for each flow. A flow may be defined as a set of packets whose headers match a given pattern of bits; in this sense, traditional IP forwarding is also flow-based forwarding where the flows defined by the destination IP address for example; however, in other implementations the given pattern of bits used for a flow definition may include more fields (e.g., 10 or more) in the packet headers. Different NDs/NEs/VNEs of the data plane 980 may receive different messages, and thus different forwarding information. The data plane 980 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 980, the packet (or a subset of the packet header and content) is typically forwarded to the centralized control plane 976. The centralized control plane 976 will then program forwarding table entries into the data plane 980 to accommodate packets belonging to the flow of the unknown packet. Once a specific forwarding table entry has been programmed into the data plane 980 by the centralized control plane 976, the next packet with matching credentials will match that forwarding table entry and take the set of actions associated with that matched entry.

### ALTERNATIVE EMBODIMENTS

The operations in the flow diagrams have been described with reference to the exemplary embodiments of the other diagrams. However, it should be understood that the operations of the flow diagrams can be performed by embodiments of the invention other than those discussed with reference to these other diagrams, and the embodiments of the invention discussed with reference these other diagrams can perform operations different than those discussed with reference to the flow diagrams.

Similarly, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a network controller of visual logging, the method comprising:
receiving one or more log entries from one of a plurality of network elements in a network, wherein the one or more log entries indicate the occurrence of one or more events on the network;
converting the one or more log entries into one or more graph log entries using a set of one or more graph log commands, wherein log entries of a certain type are associated with a corresponding graph identifier; and
storing the one or more graph log entries in a graph log file of the corresponding graph identifier.

2. The method of claim 1, wherein the one or more graph log commands includes at least one of an add graph command, a delete graph command, an add node command, a delete node command, an add edge command, a delete edge command, and an add event command.

3. The method of claim 2, wherein each of the one or more graph log commands includes as a parameter at least a graph identifier, an event identifier, a metadata entry, and a visual attributes entry.

4. The method of claim 2, wherein the add node command and the delete node command each include as parameters a node identifier.

5. The method of claim 2, wherein the add edge command and the delete edge command each include as parameters a first node identifier and a second node identifier, wherein the first node identifier identifies the source of the edge and the second node identifier identifies the destination of the edge.

6. The method of claim 1, further comprising:
receiving one or more query commands including the graph identifier; and
displaying the graph corresponding to the graph identifier based on the query command.

7. The method of claim 6, wherein the one or more query commands includes at least one of a get time duration command, a get all events command, a display graph at a first timestamp command, a display graph between the first timestamp and a second timestamp command, and a get event information command.

8. An apparatus for visual logging, comprising:
a processor and a non-transitory machine readable storage medium, said storage medium containing instructions executable by said processor whereby said apparatus is operative to:
receive one or more log entries from one of a plurality of network elements in a network, wherein the one or more log entries indicate the occurrence of one or more events on the network,
convert the one or more log entries into one or more graph log entries using a set of one or more graph log commands, wherein log entries of a certain type are associated with a corresponding graph identifier, and
store the one or more graph log entries in a graph log file of the corresponding graph identifier.

9. The apparatus of claim 8, wherein the one or more graph log commands includes at least one of an add graph command, a delete graph command, an add node command, a delete node command, an add edge command, a delete edge command, and an add event command.

10. The apparatus of claim 9, wherein each of the one or more graph log commands includes as a parameter at least a graph identifier, an event identifier, a metadata entry, and a visual attributes entry.

11. The apparatus of claim 9, wherein the add node command and the delete node command each include as parameters a node identifier.

12. The apparatus of claim 9, wherein the add edge command and the delete edge command each include as parameters a first node identifier and a second node identifier, wherein the first node identifier identifies the source of the edge and the second node identifier identifies the destination of the edge.

13. The apparatus of claim 8, wherein the apparatus is further operative to:
receive one or more query commands including the graph identifier; and
display the graph corresponding to the graph identifier based on the query command.

14. The apparatus of claim 13, wherein the one or more query commands includes at least one of a get time duration command, a get all events command, a display graph at a first timestamp command, a display graph between the first timestamp and a second timestamp command, and a get event information command.

15. A non-transitory computer readable medium, having stored thereon a computer program, which when executed by a processor performs the following operations:
receiving one or more log entries from one of a plurality of network elements in a network, wherein the one or more log entries indicate the occurrence of one or more events on the network,
converting the one or more log entries into one or more graph log entries using a set of one or more graph log commands, wherein log entries of a certain type are associated with a corresponding graph identifier, and
storing the one or more graph log entries in a graph log file of the corresponding graph identifier.

16. The non-transitory computer medium of claim 15, wherein the one or more graph log commands includes at least one of an add graph command, a delete graph command, an add node command, a delete node command, an add edge command, a delete edge command, and an add event command.

17. The non-transitory computer medium of claim 16, wherein each of the one or more graph log commands includes as a parameter at least a graph identifier, an event identifier, a metadata entry, and a visual attributes entry.

18. The non-transitory computer medium of claim 16, wherein the add node command and the delete node command each include as parameters a node identifier.

19. The non-transitory computer medium of claim 16, wherein the add edge command and the delete edge command each include as parameters a first node identifier and a second node identifier, wherein the first node identifier identifies the source of the edge and the second node identifier identifies the destination of the edge.

20. The non-transitory computer medium of claim 15, wherein the operations further include:
receiving one or more query commands including the graph identifier; and
displaying the graph corresponding to the graph identifier based on the query command.

21. The non-transitory computer medium of claim 20, wherein the one or more query commands includes at least one of a get time duration command, a get all events command, a display graph at a first timestamp command, a display graph between the first timestamp and a second timestamp command, and a get event information command.
